(19) United States
(12) Patent Application Publication
(10) Pub. No.: US 2020/0026121 A1
(43) Pub. Date: Jan. 23, 2020

(54) DISPLAY PANEL AND DISPLAY DEVICE

(71) Applicants: HKC CORPORATION LIMITED, Shenzhen, Guangdong (CN); CHONGQING HKC OPTOELECTRONICS TECHNOLOGY CO., LTD., Jeshi, Chongqing (CN)

(72) Inventor: Yu-jen CHEN, Jieshi (CN)

(73) Assignees: HKC Corporation Limited, Shenzhen, Guangdong (CN); Chongqing HKC Optoelectronics Technology Co., Ltd., Jeshi, Chongqing (CN)

(21) Appl. No.: 15/744,183

(22) PCT Filed: Aug. 31, 2017
(86) PCT No.: PCT/CN2017/100031

§ 371 Date: Sep. 27, 2018

(30) Foreign Application Priority Data
Mar. 24, 2017 (CN) 201710185898.8

(51) Int. Cl. G02F 1/1335

(52) U.S. Cl. CPC G02F 1/133512; G02F 1/133528

(57) ABSTRACT

Provided are a display panel and display device. The display panel includes a liquid crystal cell including a first substrate and a second substrate disposed opposite to each other; a liquid crystal layer disposed between the first substrate and the second substrate; a first polarizer attached to a surface of the second substrate; and at least two light-blocking portions attached to one or more lateral surfaces of the second substrate and formed from the first polarizer or the at least two light-blocking portions formed from the second substrate.

### TECHNICAL FIELD

The present disclosure relates to the field of display techniques and, in particular, to a display panel and a display device using the display panel.

### BACKGROUND

To highlight a sense of unity of a display image, a thin film transistor liquid crystal display device is developing towards a bezelless design. After the bezel is cancelled, a light leakage problem at edges of a panel should be solved first; otherwise, the liquid crystal display device has a poor display effect. At present, a solution is to coat the edges of the panel of the bezelless product with a black adhesive layer for absorbing and blocking light. However, this method requires additional materials and manufacturing processes and thus is inconvenient. Moreover, this method causes the display device to have a poor aesthetic appearance.

### SUMMARY

The present disclosure provides a display panel having a simple structure and capable of reducing a light leakage.

The display panel of the present disclosure includes:

a first substrate having a first surface, a second surface and a plurality of lateral surfaces;

a second substrate having a first surface, a second surface and a plurality of lateral surfaces, where the second surface of the first substrate and the second surface of the second substrate are opposite to each other, and each of the plurality of lateral surfaces is substantially vertical to the first surface and the second surface;

a liquid crystal layer disposed between the first substrate and the second substrate;

a first polarizer attached to the first surface of the second substrate; and

at least two light-blocking portions bonded to one or more of the plurality of lateral surfaces of the second substrate, where the at least two light-blocking portions are a part of the first polarizer or the at least two light-blocking portions are a part of the second substrate.

The present disclosure further provides a display device including a display panel and a backlight module. The display panel includes:

a first substrate having a first surface, a second surface and a plurality of lateral surfaces;

a second substrate having a first surface, a second surface and a plurality of lateral surfaces, where each of the plurality of lateral surfaces of the second substrate is substantially vertical to the first surface and the second surface, and the second surface of the first substrate and the second surface of the second substrate are disposed opposite to each other;

a liquid crystal layer disposed between the second surface of the first substrate and the second surface of the second substrate;

a first polarizer; and

a second polarizer disposed on the first surface of the first substrate.

The first polarizer includes a body and a bent portion. The body of the first polarizer is attached to a first part of the first surface of the second substrate, and the bent portion is attached to one of the plurality of lateral surfaces of the second substrate; or the second substrate has a length greater than a length of the first substrate, and the second substrate includes a base portion and an extension portion that are formed integrally.

In the technical solutions of the present disclosure, the display panel is provided with light-blocking portions on two lateral surfaces of the second substrate, which can effectively reduce the amount of the light leakage, and the light-blocking portions are formed directly from the first polarizer or the second substrate with no use of additional materials, bringing about a convenient manufacturing process and a neat and beautiful appearance.

### BRIEF DESCRIPTION OF DRAWINGS

To illustrate solutions in embodiments of the present disclosure or in the related art more clearly, the accompanying drawings used in description of the embodiments or the related art will be described below. Apparently, the accompanying drawings described below illustrate only part of embodiments of the present disclosure, and those skilled in the art may obtain other accompanying drawings based on the accompanying drawings described below on the premise that no creative work is done.

FIG. 1 is a cross-sectional view of a display device according to an embodiment of the present disclosure.

FIG. 2 is a cross-sectional view of a display device according to another embodiment of the present disclosure.

The following lists the reference numbers in the accompanying drawings:

10: display panel, 100: display device, 11: liquid crystal cell, 111: first substrate, 113: second substrate, 1131: base portion, 1133: extension portion, 115: liquid crystal layer, 13: first polarizer, 131: body, 133: bent portion, 15: second polarizer, 30: backlight module

### DETAILED DESCRIPTION

Solutions in embodiments of the present disclosure will be described clearly and completely in conjunction with the accompanying drawings in embodiments of the present disclosure. The embodiments described below are part, not all, of embodiments of the present disclosure. Based on the embodiments described herein, all other embodiments obtained by those skilled in the art without creative work are within the scope of the present disclosure.

Moreover, terms like “first” and “second”, if used herein, are for description only and are not to be construed as indicating or implying relative importance or implicitly indicating the number of technical features as indicated. Thus, a feature defined as a “first” feature or a “second” feature may expressly or implicitly include at least one of this features. As used herein, the term “plurality” is defined as at least two, e.g., two or three, unless otherwise specified and limited.

In the present disclosure, unless otherwise specified and limited, the term “rivet”, “connect” or “fix” is to be construed in a broad sense. For example, “connect” may be construed as fixedly connect, detachably connect, or integrate; mechanically connect or electrically connect; directly connect, or indirectly connect via an intermediary; or internally connect or interact between two components, unless otherwise specified and limited. For those of ordinary skill in the art, the above terms can be construed according to specific circumstances in the present disclosure.

Furthermore, solutions in various embodiments of the present disclosure can be combined with each other on the premise that the combined solutions can be practiced by those skilled in the art. When a combination of the solutions is contradictory or impossible to practice, such combination is not within the scope of the present disclosure.

The present disclosure provides a display panel 10.

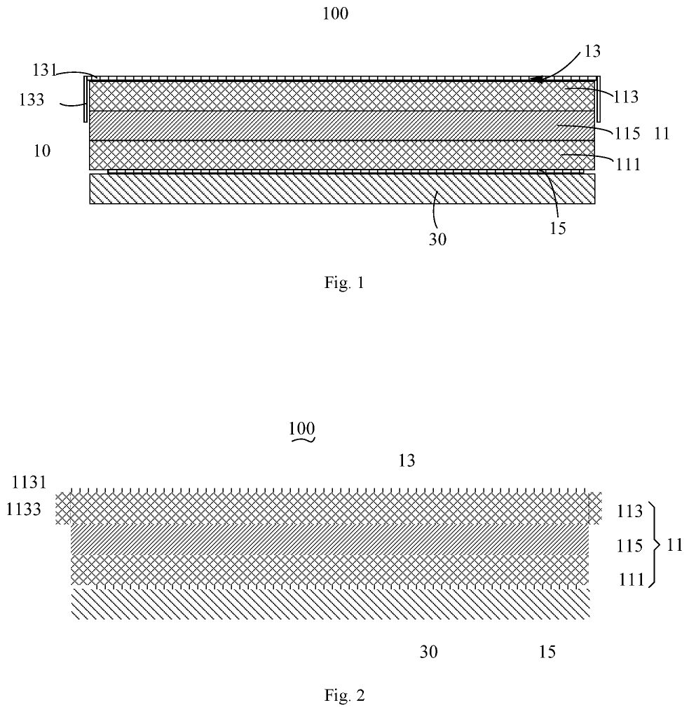

Referring to FIGS. 1 and 2, in embodiments of the present disclosure, the display panel 10 includes a liquid crystal cell 11. The liquid crystal cell 11 includes a first substrate 111 and a second substrate 113 disposed opposite to each other, a liquid crystal layer 115 disposed between the first substrate 111 and the second substrate 113; a first polarizer 13 attached to a surface of the second substrate 113; and at least two light-blocking portions, each attached to a lateral surface of the second substrate 113. In one embodiment, the light-blocking portions are a part of the first polarizer 13. In another embodiment, the light-blocking portions are a part of the second substrate 113.

In the present embodiments, the display panel 10 is a part of a display device 100, e.g., a liquid crystal display panel. The display panel 10 includes a liquid crystal cell 11, a first polarizer 13 disposed on an upper surface of the liquid crystal cell 11 and a second polarizer 15 disposed on a lower surface of the liquid crystal cell 11. The liquid crystal cell 11 includes a first substrate 111 and a second substrate 113 disposed opposite to each other. The first substrate 111 is an array substrate, and the second substrate 113 is a color filter substrate. The first substrate 111 and the second substrate 113 are bonded by a sealant to form a sealed cavity. The liquid crystal layer 115 is located in the cavity. After powered on, the two substrates can control liquid crystal molecules to rotate and control a backlight module 30 to generate light for producing an image.

The second substrate 113 in the liquid crystal cell 11 typically includes a glass substrate, a light-blocking layer, a color layer, a protective film and a conductive film. In a TFT liquid crystal display device, the glass substrate is made from alkali-free glass. The light-blocking layer is a black matrix made on the glass substrate to prevent a light leakage between pixels and enhance a color contrast. A material of the black matrix is, e.g., metal. The color layer includes a photoresist as a filter layer. A material of the color layer is, e.g., a polymer resin featured by a high transparency and a high heat resistance, and a colorant. The colorant enables the transparent polymer resin to have a color and is featured by a high light resistance, a high heat resistance, a high color saturation and a good permeability. The protective film is configured to protect the color layer and the filter layer and to increase a smoothness of a surface. The first substrate 111 is provided with a thin film transistor connected to an integrated circuit (IC) board and configured to receive a signal of the IC board.

In solutions of the present disclosure, the light-blocking portions are disposed on two lateral surfaces of the second substrate 113 of the display panel 10, effectively reducing the amount of light leakage from the two lateral surfaces of the display panel 10. The light-blocking portions are a part of the first polarizer 13 or a part of the second substrate 113, with no use of additional materials, bringing about a convenient manufacturing process and a neat and beautiful appearance.

Referring to FIG. 1, in one embodiment, the light-blocking portions are a part of the first polarizer 13. The first polarizer 13 includes a body 131 attached to the second substrate 113 and at least two bent portions 133. Two bent portions 133 are connected to two sides of the body 131 respectively and shield two lateral surfaces of the second substrate 113 respectively. The light-blocking portions are bent portions 133. The second substrate 113 is, e.g., a cube, including an upper surface, a lower surface and four lateral surfaces. For example, the body 131 of the first polarizer 13 is bonded to the upper surface of the second substrate 113. The first polarizer 13 includes two bent portions 133, i.e., a first bent portion 133 and a second bent portion 133. The first bent portion 133 is attached to and shades one lateral surface, and the second bent portion 133 is attached to and shades another lateral surface. The first bent portion 133 and the second bent portion 133 are vertical to the body 131.

In the present embodiment, the light-blocking portions of the display panel 10 are formed from the first polarizer 13, and a size of the first polarizer 13 is greater than a size of the liquid crystal cell 11. Parts, beyond the liquid crystal cell 11, of the first polarizer 13 may be directly bent towards the second substrate 113 to form the bent portions 133, i.e., the bent portions 133 located on the two lateral surfaces of the second substrate 113, to shade the two lateral surfaces of the second substrate 113. The first substrate 111 is generally connected to a circuit board on one side thereof, so the first polarizer 13 may be provided with three bent portions 133 respectively on three lateral surfaces of the second substrate 113. In general, the light leakage is serious on the two lateral surfaces of the display panel 10, so the first polarizer 13 includes at least two bent portions 133 located on the two opposite sides of the body 131. The light-blocking portions having such structures are simple and easy to operate, do not require additional materials and have a neat and beautiful appearance.

Optionally, a length of each bent portion 133 is greater than or equal to a thickness of the second substrate 113.

In the present embodiment, the first polarizer 13 has a structure capable of blocking light. To ensure that the bent portions 133 can reduce the light leakage from the two lateral surfaces of the second substrate 113, the length of each bent portion 133 is greater than or equal to the thickness of the second substrate 113, so that the bent portions 133 can completely shade two sides of the second substrate 113, thereby ensuring that the light leakage of the display panel 10 is reduced.

Further, the length of each bent portion 133 is greater than or equal to a total thickness of the second substrate 113 and the first substrate 111. Each of the two bent portions 133 light-blocking portions a respective one of the two lateral surfaces of the second substrate 113 and at least in part shades two lateral surfaces of the first substrate 111.

In the present embodiment, the length of the bent portion 133 is increased, so that the bent portion 133 can shade a larger part of the second substrate 113 and can also shade the liquid crystal layer 115 and the two lateral surfaces of the first substrate 111, further reducing a light leakage probability of the display panel 10. In solutions of the above two embodiments, the second substrate 113 and the first substrate 111 have a same area, and have simple structures not requiring alterations.

In one embodiment, the first polarizer 13 is provided with a bending line (not illustrated in the drawing) at a joint between the body 131 and each bent portion 133.

In the present embodiment, to make it easy to configure the first polarizer 13 as the body 131 and the bent portions 133 and to make it easy to bend the first polarizer 13, the bending line is provided at the joint between the body 131 and each bent portion 133. The bending line is formed from a series of holes arranged in a line and with intervals on the surface of the first polarizer 13 when the first polarizer 13 is being manufactured. Each hole may be rectangular or oval. During an assembly process, the bent portions 133 are directly bent, saving time and effort, being fast and convenient, and improving a manufacturing efficiency. In subsequent use, the bending line can prevent the bent portions 133 that have been bent from warping upwards and ensure a structural stability.

Referring to FIG. 2, in another embodiment, the light-blocking portions are formed from the second substrate 113. The second substrate 113 includes a base portion 1131 and at least two extension portions 1133 integrated with the base portion 1131. The two extension portions 1133 are beyond two lateral surfaces of the first substrate 111. The extension portions 1133 are the light-blocking portions. The extension portions 1133 and the base portion 1131 are at the same level. In the present embodiment, the second substrate 113 has a length greater than a length of the first substrate 111.

In the present embodiment, the light-blocking portions are formed directly from the second substrate 113. A size of the second substrate 113 may be directly increased when the second substrate 113 is being manufactured. The base portion 1131 has sizes same as sizes of the first substrate 111, and the extension portions 1133 are parts, beyond the first substrate 111, of the second substrate 113, i.e., the light-blocking portions. In the present embodiment, the extension portions 1133 do not affect a connection of the first substrate 111 to a circuit board, and thus can be uniformly formed around the base portion 1131, thereby better reducing the light leakage. A reason why the extension portions 1133 can block light is that each extension portion 1133 includes a color photoresist and a light-blocking layer capable of fully reducing the light leakage.

The extension portions 1133 and the base portion 1131 are formed integrally, not requiring additional manufacturing processes and thus being simple, convenient and cost-effective. The second substrate 113 in an integrated structure has a better structural stability. Light-blocking components of the extension portions 1133 are disposed inside, facilitating a neat surface and beautiful appearance.

When the light-blocking portions are formed from the second substrate 113, the first polarizer 13 may have a width less than or equal to a width of the second substrate 113. When the width of the first polarizer 13 is less than the width of the second substrate 113, the width of the first polarizer 13 may be the same as the width of the base portion 1131, not affecting shading effects the extension portions 1133. When the width of the first polarizer 13 is equal to the width of the second substrate 113, the first polarizer 13 may block off the light leakage together with the extension portions 1133, thereby further reducing a light leakage probability.

Additionally, in the above embodiments, the display panel 10 includes a second polarizer 15 disposed on a surface of the first substrate 111 facing away from the first polarizer 13. The sizes of the second polarizer 15 are not changed as compared to an existing display panel and may be less than or equal to the sizes of the first substrate 111.

The present disclosure further provides a display device 100 including a display panel 10 and a backlight module 30. The display panel 10 is the display panel 10 described above. The backlight module 30 is disposed on a side of the display panel 10 facing away from the first polarizer 13. The display panel 10 of the display device 100 employs the solutions of all the above embodiments, and therefore has at least all beneficial effects brought about by the solutions of all the above embodiments. These beneficial effects will not be repeated here.

In the present embodiment, the backlight module 30 is disposed near the second polarizer 15 and is configured to provide a uniform and bright light source for the display device 100. The backlight module 30 generally includes a light source, a light guide plate, a reflector plate and an optical film. The reflector plate may be a reflective coating applied to a surface of the light guide plate. The light guide plate can convert the light source from a point light source into a uniform surface light source. The reflector plate can prevent light entering the light guide plate from emitting from a side away from an exit surface and then reflect it back into the light guide plate, thereby avoiding a waste of light energy and improving a light utilization rate. Since backlight is provided by the backlight module 30, the display device 100 can provide a better display effect.

The above are only the embodiments of the present disclosure and are not intended to limit the scope of the present disclosure. Direct or indirect utilization of the specification and accompanying drawings of the present disclosure in equivalent structural variations or in the related art without departing from the spirit of the present disclosure is within the scope of the present disclosure.

What is claimed is:

1. A display panel, comprising:
a first substrate having a first surface, a second surface and a plurality of lateral surfaces;
a second substrate having a first surface, a second surface and a plurality of lateral surfaces, wherein the second surface of the first substrate and the second surface of the second substrate are disposed opposite to each other, and each of the plurality of lateral surfaces is substantially vertical to the first surface and the second surface;
a liquid crystal layer disposed between the first substrate and the second substrate;
a first polarizer attached to the first surface of the second substrate; and
at least two light-blocking portions attached to one or more of the plurality of lateral surfaces of the second substrate, wherein the at least two light-blocking portions are a part of the first polarizer or the at least two light-blocking portions are a part of the second substrate.

2. The display panel of claim 1, wherein the at least two light-blocking portions are the part of the first polarizer, and the first polarizer comprises a body attached to the first surface of the second substrate and at least two bent portions, wherein the at least two bent portions are connected to the body and are the at least two light-blocking portions.

3. The display panel of claim 2, wherein a length of each of the at least two bent portions is greater than or equal to a thickness of the second substrate.

4. The display panel of claim 2, wherein a length of each of the at least two bent portions is greater than or equal to a sum of a thickness of the second substrate and a thickness of the first substrate, wherein the at least two bent portions comprise a first bent portion and a second bent portion, the first bent portion shades a part of one of the plurality of lateral surfaces of the first substrate, and the second bent portion shades a part of another one of the plurality of lateral surfaces of the first substrate.

5. The liquid crystal display panel of claim 2, wherein a joint between the body and each of the at least two bent portions is provided with a groove.

6. The liquid crystal display panel of claim 3, wherein a joint between the body and each of the at least two bent portions is provided with a groove.

7. The liquid crystal display panel of claim 4, wherein a joint between the body and each of the at least two bent portions is provided with a groove.

8. The display panel of claim 2, wherein the second substrate has an area same as an area of the first substrate.

9. The display panel of claim 1, wherein the at least two light-blocking portions are the part of the second substrate and the second substrate comprises a base portion and at least two extension portions connected to a periphery of the base portion, wherein at least two of the at least two extension portions and the base portion are formed integrally and the at least two extension portions are the at least two light-blocking portions.

10. The liquid crystal display panel of claim 9, wherein a width of the first polarizer is less than or equal to a width of the second substrate.

11. The display panel of claim 1, further comprising a second polarizer disposed on the first surface of the first substrate.

12. A display device, comprising a display panel and a backlight module, wherein the display panel comprises:
a first substrate having a first surface, a second surface and a plurality of lateral surfaces;
a second substrate having a first surface, a second surface and a plurality of lateral surfaces, wherein each of the plurality of lateral surfaces of the second substrate is substantially vertical to the first surface and the second surface, and the second surface of the first substrate and the second surface of the second substrate are opposite to each other;
a liquid crystal layer disposed between the second surface of the first substrate and the second surface of the second substrate;
a first polarizer; and
a second polarizer disposed on the first surface of the first substrate,
wherein the first polarizer comprises a body and a bent portion, the body of the first polarizer is attached to a first part of the first surface of the second substrate, and the bent portion is attached to one of the plurality of lateral surfaces of the second substrate; or a length of the second substrate is greater than a length of the first substrate, and the second substrate comprises a base portion and an extension portion that are formed integrally.

13. The display device of claim 12, wherein a length of the bent portion is greater than or equal to a thickness of the second substrate.

14. The display device of claim 12, wherein a length of the bent portion is greater than a thickness of the second substrate and less than a sum of the thickness of the second substrate and a thickness of the first substrate, the bent portion completely shades a respective one of the plurality of lateral surfaces of the second substrate and shades a part of a respective one of the plurality of lateral surface of the first substrate.

15. The display device of claim 12, wherein a groove is disposed between the body and the bent portion of the first polarizer.

16. The display device of claim 12, wherein the second substrate has an area same as an area of the first substrate when the first polarizer comprises the body and the bent portion.

17. The display device of claim 12, wherein a width of the first polarizer is less than or equal to a width of the second polarizer, when the length of the second substrate is greater than the length of the first substrate and the second substrate comprises a base portion and an extension portion that are formed integrally.

18. The display device of claim 12, wherein a projection of the first substrate on the second substrate substantially coincides with the base potion of the second substrate when the length of the second substrate is greater than the length of the first substrate and the second substrate comprises a base portion and an extension portion that are formed integrally.

19. The display device of claim 12, wherein the bent portion comprises a first bent portion and a second bent portion, the first bent portion is attached to one of the plurality of lateral surfaces of the second substrate, and the second bent portion is attached to another one of the plurality of lateral surfaces of the second substrate.

20. The display device of claim 12, wherein the first substrate is an array substrate, and the second substrate is a color filter substrate.
